(19) United States
(12) Patent Application Publication
(10) Pub. No.: US 2025/0388175 A1
(43) Pub. Date: Dec. 25, 2025

(54) ELECTRONIC REARVIEW MIRROR AND DISPLAY METHOD OF ELECTRONIC REARVIEW MIRROR

(71) Applicant: NEXTPERT INC., New Taipei (TW)

(72) Inventors: HSIN-HUNG LEE, New Taipei (TW); CHENG-FENG YEH, New Taipei (TW); PO-YUEH HSIEH, New Taipei (TW); SHOA-HUNG YANG, New Taipei (TW); WEN-YI KUO, Taipei (TW)

(21) Appl. No.: 19/243,827

(22) Filed: Jun. 20, 2025

(30) Foreign Application Priority Data
Jun. 21, 2024 (TW) 113123289

(51) Int. Cl. B60R 1/28; G06F 3/01; H04N 7/18; H04N 23/62; H04N 23/69

(52) U.S. Cl. CPC B60R 1/28; H04N 7/181; H04N 23/62; H04N 23/69; B60R 2300/105; B60R 2300/30; B60R 2300/70; B60R 2300/8046; G06F 3/012; G06F 3/013

(57) ABSTRACT

An electronic rearview mirror and a display method of the electronic rearview mirror are provided, the electronic rearview mirror includes at least one camera configured to capture external images on both sides of a vehicle; at least one electronic display configured to display the external images on both sides of the vehicle captured by the at least one camera; a sensor configured to detect a position of a driver's head in a driver's seat of the vehicle and a head change amount between the head and the at least one electronic display; and a processor configured to adjust the external images displayed on the electronic display according to the head change amount.

### CROSS-REFERENCE TO RELATED APPLICATIONS

This application claims priority to Taiwan Patent Application No. 113123289 filed on Jun. 21, 2024, in Taiwan Intellectual Property Office, the contents of which are incorporated by reference herein.

### FIELD

The subject matter herein generally relates to automotive technology field, and more particularly to an electronic rearview mirror and a display method of the electronic rearview mirror.

### BACKGROUND

Generally, a vehicle is provided with a flat reflector on both sides of the vehicle doors as rearview mirrors, so that the vehicle driver can observe the scene behind the vehicle. With the development of technology, cameras are installed on both sides of vehicle doors to capture images behind the vehicle, and a display is installed in the vehicle cab to display the images captured by the cameras. However, since the driver needs to observe different directions according to the actual situation while driving the vehicle, and needs to observe different scene ranges in the rearview mirrors accordingly, if the images captured by the cameras displayed on the display cannot be adjusted according to the actual needs of the driver, it will be extremely inconvenient for the driver to drive.

### BRIEF DESCRIPTION OF THE DRAWINGS

Implementations of the present disclosure will now be described, by way of embodiments, with reference to the attached figures.

FIG. 1 is a schematic diagram of a vehicle according to an embodiment of the present application.

FIG. 2 is a schematic diagram of an electronic rearview mirror according to an embodiment of the present application.

FIG. 3 is an application scenario diagram of the electronic rearview mirror according to an embodiment of the present application.

FIG. 4 is an application scenario diagram of the electronic rearview mirror according to an embodiment of the present application.

FIG. 5 is another application scenario diagram of the electronic rearview mirror according to an embodiment of the present application.

FIG. 6 is another application scenario diagram of the electronic rearview mirror according to an embodiment of the present application.

FIG. 7 is another application scenario diagram of the electronic rearview mirror according to an embodiment of the present application.

FIG. 8 is another application scenario diagram of the electronic rearview mirror according to an embodiment of the present application.

FIG. 9 is another application scenario diagram of the electronic rearview mirror according to an embodiment of the present application.

FIG. 10 is a flowchart of a display method of the electronic rearview mirror according to an embodiment of the present application.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

An embodiment of the present application provides an electronic rearview mirror, which is used in a vehicle to capture the external scene behind the vehicle, provide the driver with external images behind the vehicle, and adjust the position of the displayed external image in real time according to the driver's posture changes during driving, so as to provide external images of the vehicle suitable for the driver's needs, meet the driver's real-time driving needs, and greatly facilitate the driver's driving.

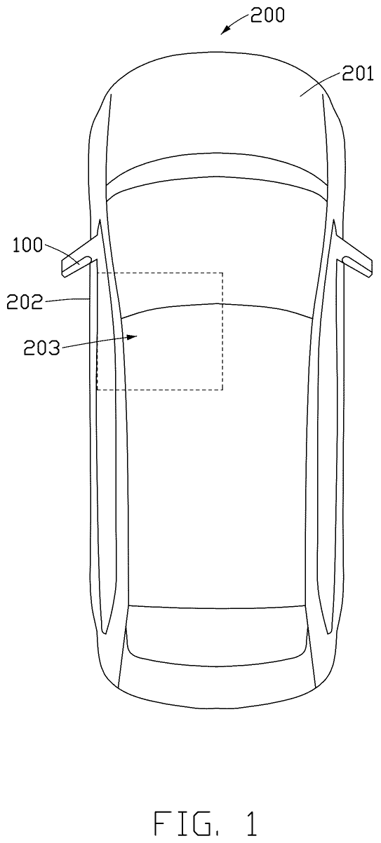

Referring to FIG. 1, the present application provides the electronic rearview mirror 100 applied in the vehicle 200. In some embodiments, the vehicle 200 includes a vehicle body 201, vehicle doors 202, and a driver's seat 203. The vehicle doors 202 are arranged on the vehicle body 201, and can also be a part of the vehicle body 201. The vehicle 200 can be provided with a plurality of vehicle doors 202. The driver's seat 203 is arranged in the vehicle body 201 and corresponds to one of the vehicle doors 202, and the driver's seat 203 provides a space for the driver to drive the vehicle.

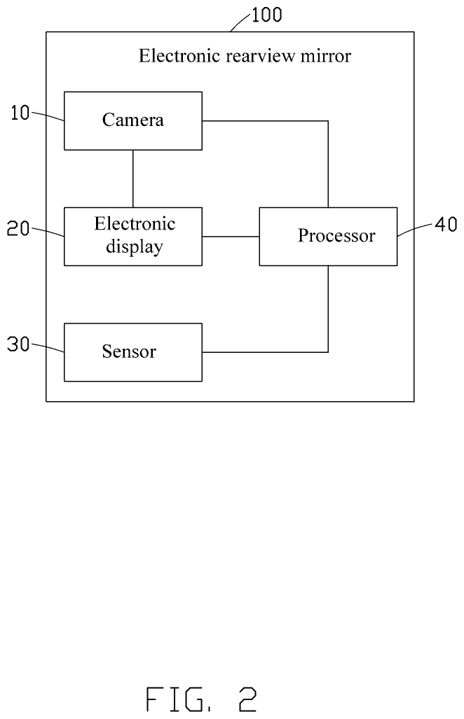

Referring to FIGS. 2 to 5, the present application provides the electronic rearview mirror 100 including at least one camera 10, at least one electronic display 20, a sensor 30, and a processor 40.

The at least one camera 10 is used to capture external images on both sides of the vehicle. In some embodiments, the at least one camera 10 can be installed on the outside of the vehicle door 202 corresponding to the driver's seat 203, and the at least one camera 10 faces the rear of the vehicle to capture external images behind the vehicle. The cameras 10 can be installed on the outside of the vehicle doors 202 on both sides of the vehicle body 201 to capture external images on both sides of the vehicle. In other embodiments, only one camera 10 may be installed at a rear end of the vehicle body 201 to capture external images on both sides of the vehicle. In some embodiments, at least one camera 10 may be, but is not limited to, a camera or video camera with high dynamic range, high resolution, wide field of view, and high sensitivity at night.

The at least one electronic display 20 is used to display the external images on both sides of the vehicle captured by the at least one camera 10. The at least one electronic display 20 can display the external images on both sides of the vehicle captured by the at least one camera 10 in real time, so that the driver can observe the scene behind the vehicle through the screen displayed by the at least one electronic display 20, realizing the function of rearview mirrors. In some embodiments, the at least one electronic display 20 can be installed on the inner side of the vehicle door 202 corresponding to the driver's seat 203 and is arranged corresponding to the at least one camera 10. The at least one electronic display 20 is electrically connected to the at least one camera 10 to receive and display the real-time external images captured by the at least one camera 10. The electronic display 20 can be installed at the vehicle doors 202 on both sides of the vehicle body 201 to respectively display the external images of both sides of the vehicle body 201 captured by the corresponding camera 10. In other embodiments, when only one camera 10 is installed at the rear end of the vehicle body 201, only one electronic display 20 may be installed in the vehicle body 201 to display the external images of both sides of the vehicle captured by the camera 10. In some embodiments, the at least one electronic display 20 may be, but is not limited to, an LCD display, an OLED display, a Micro-LED display, a projector, etc.

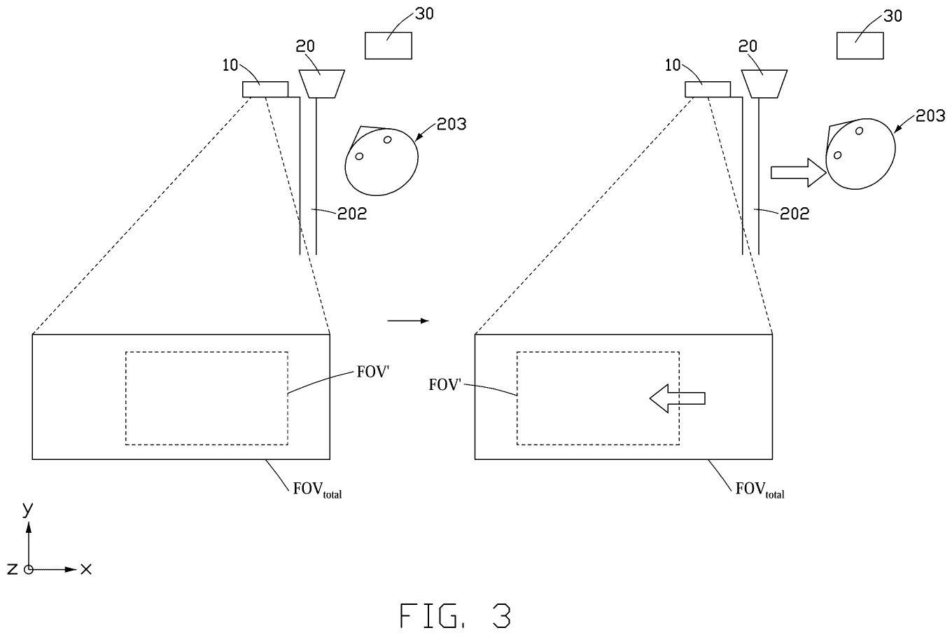

In some embodiments, the at least one camera 10 is a camera with a wide field of view, having a capturing range, such as the capturing range FOVₜₒₜₐₗ shown in FIG. 3, and the at least one camera 10 shoots the scene within the capturing range. The at least one electronic display 20 displays a portion of the scene within the capturing range of the at least one camera 10, that is, the display range of the at least one electronic display 20 is a portion of the capturing range of the at least one camera 10, such as the display range FOV′ shown in FIG. 3. According to the setting, the display range of the at least one electronic display 20 can be a preset magnification of the capturing range of the at least one camera 10, such as 40%, 50%, 60%, etc., and the present application does not limit this. The display range of the at least one electronic display 20 is a preset magnification of the capturing range of the at least one camera 10, which can make the display images of the at least one electronic display 20 clearer, reflect more details of the scene, and provide a better observation field of view. In some embodiments, the display range of the at least one electronic display 20 can be a default position of the capturing range of the at least one camera 10.

The sensor 30 is used to detect the position of the driver's head in the driver's seat 203 of the vehicle and the head change amount between the head and the at least one electronic display 20. In some embodiments, the sensor 30 can be installed in the driver's seat 203 and correspond to the position of the driver's head relative to the at least one electronic display 20 when the driver is in the driver's seat 203, so as to detect the head change amount between the driver's head and the at least one electronic display 20 in real time. For example, the sensor 30 may be installed at the rearview mirror inside the vehicle, at the central control display screen, near the steering wheel, etc., within the position of the driver's seat 203, so as to conveniently detect the position of the driver's head relative to the at least one electronic display 20 when the driver is in the driver's seat 203. In some embodiments, the sensor 30 may be installed on the at least one electronic display 20 to more directly and accurately detect the position of the driver's head relative to the at least one electronic display 20 when the driver is in the driver's seat 203. In some embodiments, the sensor 30 can detect a first position of the driver's head relative to the at least one electronic display 20 at a first moment t1, and detect a second position of the driver's head relative to the at least one electronic display 20 at a second moment t2, and obtain the head change amount between the driver's head and the at least one electronic display 20 by comparing the second position with the first position.

In some embodiments, the sensor 30 may be, but is not limited to, a charge coupled device (CCD) camera, a complementary metal-oxide-semiconductor transistor (CMOS) sensor, an infrared radiation (IR) camera, a time of flight (ToF) sensor, a structured light sensor, a thermal imaging sensor, etc. In some embodiments, the sensor 30 may be an eye sensor or an iris sensor, etc. The sensor 30 may be used to detect the driver's eyes. The sensor 30 may detect the movement amount of the eyes between the driver's eyes and the at least one electronic display 20 to obtain the head change amount of the driver. In some embodiments, the head change amount of the driver may include a changing distance and a changing angle between the eyes and the at least one electronic display 20.

The processor 40 is used to adjust the external images displayed on the electronic display 20 according to the head change amount. In some embodiments, the display range of the at least one electronic display 20 can be a default position of the capturing range of the at least one camera 10. According to the head change amount between the driver's head and the at least one electronic display 20 detected by the sensor 30, the processor 40 adjusts the at least one electronic display 20 to display an image of another position of the capturing range of the at least one camera 10, so that the external image displayed by the at least one electronic display 20 maps the head change amount of the driver, which meets the driver's observation needs.

In some embodiments, the processor 40 adjusts the external image displayed on the electronic display 20 according to the head change amount, which may include cropping or zooming in/out the external image captured by at least one camera 10, and adjusting the ratio of the external images displayed on the at least one electronic display 20 to the capturing range of the at least one camera 10, so as to adjust the ratio of the external images displayed on the electronic display 20 (similar to zoom in or zoom out effect). For example, the display range of the at least one electronic display 20 defaults to a preset magnification of the capturing range of at least one camera 10, such as 40%. The processor 40 adjusts the magnification of the display range of the at least one electronic display 20 to the capturing range of the at least one camera 10 according to the head change amount, such as 50%, adjusting from 40% to 50%, thereby adjusting the screen size of the external image captured by the at least one camera 10 (similar to zoom in effect) to adapt to the driver's demand for observing the image from a distance.

In detail, when the sensor 30 detects that the distance between the driver's head and the at least one electronic display 20 is decreased, the processor 40 increases the screen size of the external image displayed on the at least one electronic display 20 (similar to zoom in effect). When the driver's head is close to the at least one electronic display 20, that is, when the sensor 30 detects that the distance between the driver's head and the at least one electronic display 20 is decreased, it can be inferred that the driver wants to see the display screen of the at least one electronic display 20 clearly or wants to see more details of the display screen, so the processor 40 increases the screen size of the external image displayed on the at least one electronic display 20 (similar to zoom in effect) to display an enlarged screen and display more details. When the sensor 30 detects that the distance between the driver's head and the at least one electronic display 20 is increased, the processor 40 decreases the screen size of the external image displayed on the at least one electronic display 20 (similar to zoom out effect). When the driver's head is away from the at least one electronic display 20, that is, when the sensor 30 detects that the distance between the driver's head and the at least one electronic display 20 increases, it can be inferred that the driver wants to observe a larger range of the display screen of the at least one electronic display 20, and the processor 40 decreases the screen size of the external image displayed on the at least one electronic display 20 (similar to zoom out effect) to show a wider screen field of view.

In other embodiments, the processor 40 may adjust the position of the electronic display 20 displaying the external image according to the head change amount, which may include moving the position of the at least one electronic display 20 displaying the external image, and adjusting the at least one electronic display 20 to display the image of another position within the capturing range of at least one camera 10, so as to adjust the position of the at least one electronic display 20 displaying the external image. For example, the display range of the at least one electronic display 20 is adjusted to move in a direction within the capturing range of the at least one camera 10, such as moving to the left, thereby adjusting the position of at least one electronic display 20 displaying the external image to adapt to the driver's demand for the direction of observing the picture.

In detail, when the sensor 30 detects that the head changes relative to the at least one electronic display 20 in the first direction, the processor 40 adjusts the position of the at least one electronic display 20 displaying the external image to move in a second direction opposite to the first direction. Exemplarily, the first direction may be, for example, the x-axis direction shown in FIG. 3, and the second direction may be the −x-axis direction opposite to the x-axis direction shown in FIG. 3; or, the first direction may be, for example, the −x-axis direction opposite to the x-axis direction shown in FIG. 3, and the second direction may be the x-axis direction shown in FIG. 3; or, the first direction may be, for example, the y-axis direction shown in FIG. 3, and the second direction may be the −y-axis direction opposite to the y-axis direction shown in FIG. 3; or, the first direction may be, for example, the −y-axis direction opposite to the y-axis direction shown in FIG. 3, and the second direction may be the y-axis direction shown in FIG. 3; or, the first direction may be, for example, the z-axis direction shown in FIG. 3, and the second direction may be the −z-axis direction opposite to the z-axis direction shown in FIG. 3; or, the first direction may be, for example, the −z-axis direction opposite to the z-axis direction shown in FIG. 3, and the second direction may be the z-axis direction shown in FIG. 3. For example, when the sensor 30 detects that the driver's head moves to the left (e.g., in the −x-axis direction opposite to the x-axis direction shown in FIG. 3) relative to the at least one electronic display 20, it can be inferred that the driver wants to observe an external image further to the right of the at least one electronic display 20, and the processor 40 adjusts the position of the at least one electronic display 20 displaying the external image to the right (e.g., in the x-axis direction shown in FIG. 3) to provide the driver with an external image further to the right. For another example, when the sensor 30 detects that the driver's head moves upward relative to the at least one electronic display 20 (for example, in the y-axis direction shown in FIG. 3), it can be inferred that the driver wants to observe an external image further downward the at least one electronic display 20, and the processor 40 adjusts the position of the at least one electronic display 20 displaying the external image downward (for example, in the −y-axis direction opposite to the y-axis direction shown in FIG. 3) to provide the driver with an external image further downward.

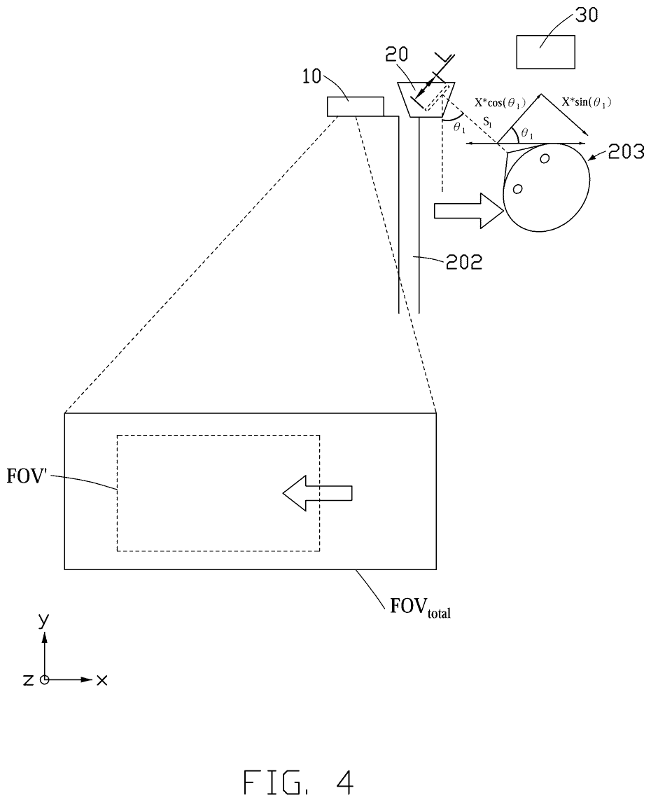

Referring to FIG. 4, in some embodiments, when the driver is driving in the driver's seat 203 in the vehicle, at the first moment t1, the sensor 30 detects that the distance between the driver's eyes and the at least one electronic display 20 is S1, the at least one electronic display 20 has a width L, the field of view (FOV) of the eyes can be FOV=2*arctan (L/2/S1), the capturing range of the at least one camera 10 can be FOVₜₒₜₐₗ, and the display range of the at least one electronic display 20 can be FOV′, wherein the FOV of the eyes and the display range FOV′ of the at least one electronic display 20 have a magnification M. At the second moment t2, when the sensor 30 detects that the driver's head moves a distance x in the horizontal direction (i.e., along the x-axis direction shown in the figures), the FOV of the eyes also moves relatively accordingly. The sensor 30 detects that the angle between a connection line between the driver's head and the at least one electronic display 20 and the y-axis direction is θ1, and the processor 40 (not shown) adjusts the position of the at least one electronic display 20 displaying the external image to move x*cos(θ1) in the horizontal direction of the at least one electronic display 20, and adjusts the position of the at least one electronic display 20 displaying the external image to move x*sin(θ1) in the normal direction of the at least one electronic display 20. If the magnification of the at least one electronic display 20 is 1, then according to the law of reflection, the FOV of the eyes moves −2*arctan (x*cos(θ1)/S1). If the magnification of the at least one electronic display 20 is M, then the display range of the at least one electronic display 20 is FOV′=FOV/M. Therefore, the display range FOV′ of the at least one electronic display 20 moves by −2*(arctan (x*cos(θ1)/S1))/M, and the size change of the display range FOV′ of the at least one electronic display 20 is S1/(S1+x*sin(θ1)), which is inversely proportional to the distance from the at least one electronic display 20 to the eyes.

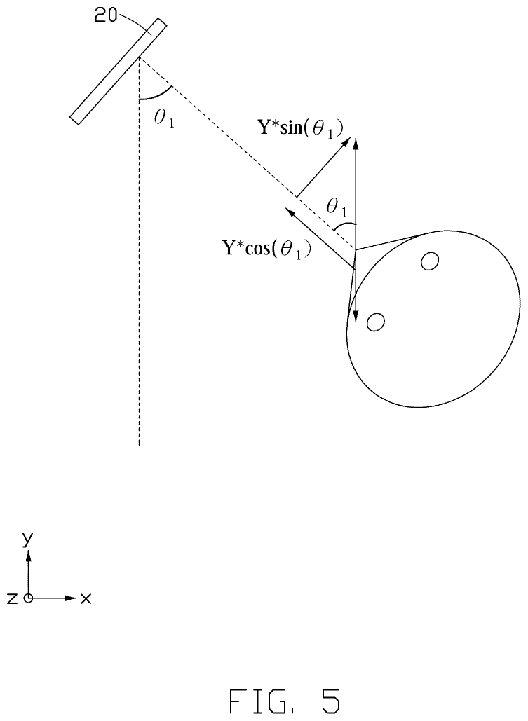

Referring to FIG. 5, in other embodiments, when the sensor 30 (not shown) detects that the driver's head moves forward (i.e., along the y-axis direction shown in the figure) by a distance y, the processor 40 (not shown) adjusts the position of the at least one electronic display 20 displaying the external image to move y*sin(θ1) in the horizontal direction of the at least one electronic display 20, adjusts the position of the at least one electronic display 20 displaying the external image to move y*cos(θ1) in the normal direction of the at least one electronic display 20, and the display range FOV′ of the at least one electronic display 20 moves −2*(arctan (y*sin(θ1)/S1))/M, and the size change of the display range FOV′ of the at least one electronic display 20 is S1/(S1−y*cos(θ1)). In other embodiments, when the sensor 30 detects that the driver's head moves a distance z in the vertical direction (i.e., along the z-axis direction shown in the figure), the display range FOV′ of the at least one electronic display 20 moves by −2*(arctan (z/S1))/M.

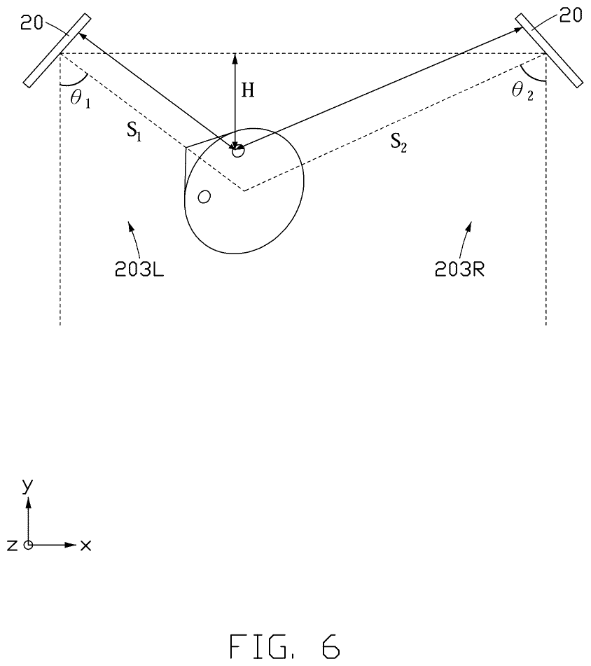

Referring to FIG. 6, in other embodiments, when the electronic display 20 is installed at each door on both sides of the vehicle body, the distance between the driver's eyes and the electronic display 20 installed on the main driver's seat 203L (i.e., the left driver's seat as shown in FIG. 6) is S1, the distance between the driver's eyes and the electronic display 20 installed on the co-driver's seat 203R (i.e., the right driver's seat as shown in FIG. 6) is S2, and the vertical distance between the driver's eyes and the x-axis direction axis of the at least one electronic display 20 is H, or the vertical distance between the driver's eyes and the connection between the two electronic displays 20 is H, the angle between the driver's head and the connection line between the electronic display 20 installed on the main driver's seat 203L (i.e., the left driver's seat as shown in FIG. 6) and the y-axis direction is θ1, and the angle between the driver's head and the connection line between the electronic display 20 installed on the co-driver's seat 203R (i.e., the right driver's seat as shown in FIG. 6) and the y-axis direction is θ2. It is only necessary to substitute θ2 into the above formula for calculation, and no further explanation is given here.

Refer to Table 1, above-mentioned parameters are arranged as follows Table 1:

TABLE 1

| | | θ = Arccos(H/S), the |
|---|---|---|
| | | vertical distance H between |
| The angle θ between the | | the eyes and the x-axis |
| driver's head and the at | | direction of the two electronic |
| least one electronic display, | | displays, the distance S |
| the magnification of the at | | between the eyes and the at |
| least one electronic display is M | | least one electronic display |
| Horizontal | FOV′ movement | −2*(arctan(x *cos(θ)/S))/M |
| movement x | amount | |
| | FOV′ size | S/(S + x*sin(θ)) |
| | change | |
| Forward and | FOV′ movement | −2*(arctan(y*sin(θ)/S))/M |
| backward | amount | |
| movement y | FOV′ size | S/(S − y*cos(θ)) |
| | change | |
| Up and down | FOV′ movement | −2*(arctan(z/S))/M |
| movement | amount | |

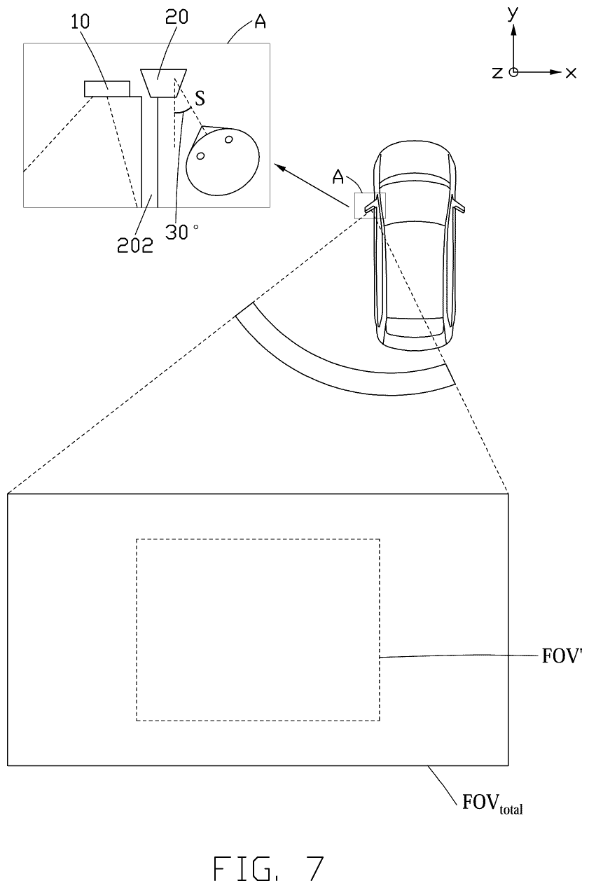

Referring to FIG. 7, in other embodiments, the capturing range FOVₜₒₜₐₗ of the at least one camera 10 is 90°, the display range FOVₜₒₜₐₗ of the at least one electronic display 20 is 153.6×85.25 mm, and the distance S between the driver's eyes and the at least one electronic display 20 is about 600 mm, then the field of view angle of the eyes FOV=2*arctan (L/2/S)=14.6°. According to the magnification limit of the regulations, it must be greater than 0.29, if the vehicle manufacturer sets it to 0.35, the display range FOV′ of the at least one electronic display 20 is 14.6°/0.35=41.7°. As shown in FIG. 7, the A area of the left figure is an enlarged viewing angle of the corresponding A area of the right figure, and shows more details of the driver's head, the at least one camera 10 and the at least one electronic display 20. If the display range FOV′ of the at least one electronic display 20 is set to be centered in the capturing range FOVₜₒₜₐₗ of the at least one camera 10. For example, if the driver's seat is located on the left side of the vehicle, if the angle between the driver's eyes and the y-axis is 30°, if the driver wants to see a larger and more left-biased display image on the electronic display 20 when turning left to avoid blind spots, the driver's head moves rightward by x=+10 mm and forward by y=+30 mm. Substituting the calculation results into Table 2 shows:

TABLE 2

| | Factor | | | | |
|---|---|---|---|---|---|
| | x movement (mm) | y movement (mm) | | | |
| Calculation | 10 | 30 | TotalΔ | −20%Δ | 20%Δ |
| FOV′ | −2*(arctan(10*cos(30°)/ | −2*(arctan(30*sin(30°)/ | −12.91 | −10.33 | −15.49 |
| movement | 600))/0.35= −4.72535 | 600))/0.35= −8.1834 | | | |
| amount (°) | | | | | |
| FOV′ size | 600/(600 + 10*sin(30°)) = | 600/(600 − 10*cos(30°)) = | 1.037 | 1.029 | 1.044 |
| change | 0.991736 | 1.045261 | | | |

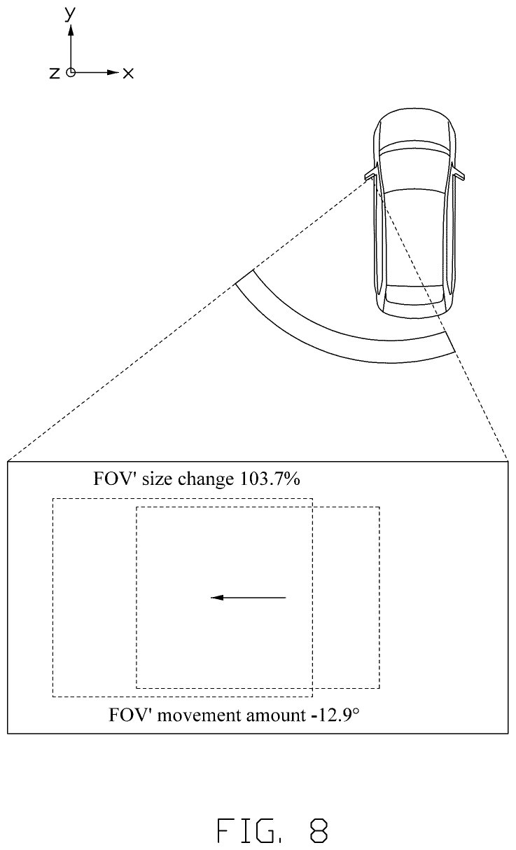

Referring to FIG. 8, in other embodiments, the driver's eyes distance will affect the ratio of the viewing angle. Taking the eyes distance of 50-75 mm as an example, the middle value is 62.5 mm, and the upper and lower limit ratio is 12.5/62.5=20%. Then, the movement amount and magnification of the display range FOV′ of the electronic display 20 should be adjustable in the range as shown in Table 3:

TABLE 3

| | | Reasonable design |
|---|---|---|
| | Calculation results | range (±20%) |
| FOV′ total | −4.7° + (−8.2°) = −12.9° | −15.5°~−10.3° |
| movement amount | | |
| FOV′ total | 0.992*1.045 = 103.7% | 102.9%~104.4% |
| size change | | |

The driver's head origin is set based on the average position of the eyes looking forward within a period of time after the viewing angle of the electronic display 20 is initially set. The sensor 30 records and stores this condition (which can be executed by the driver monitoring system (DMS)). If the viewing angle of the electronic display 20 is not reset in subsequent use, the driver's head origin will be used. If there is a change, it will be re-detected. In other embodiments, a default process may also be provided to allow the driver to manually set, such as adjusting the FOV of the driver's eyes and setting the head origin. At this time, the driver is instructed to make a driving posture, and the sensor 30 records the eyes angle of the head looking straight ahead to write the preset. When corresponding to different drivers, the electronic display 20 or a portable electronic device can be connected to the vehicle system (system on chip (SoC)) to call a dedicated head origin setting.

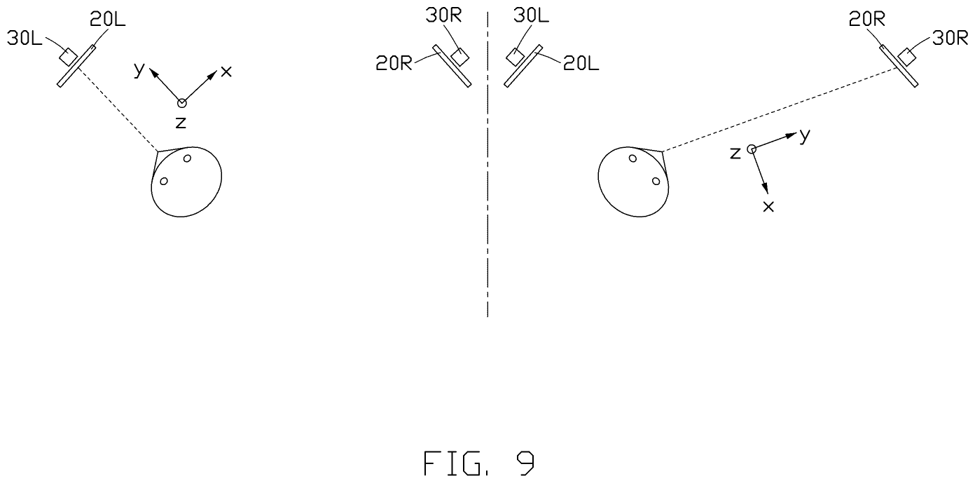

Refer to FIG. 9, in other embodiments, the electronic display may be installed at the doors on both sides of the vehicle body to respectively display the external images on both sides of the vehicle captured by the corresponding camera, and the sensor is installed on each electronic display. Each sensor may be arranged in parallel with the corresponding electronic display, or may be arranged behind the corresponding electronic display and hidden as an under panel sensor. In this embodiment, the sensor near the driver's seat (for example, on the left side of the vehicle body) can be defined as the first sensor 30L, and the electronic display near the driver's seat (for example, on the left side of the vehicle body) can be defined as the first electronic display 20L; the sensor far from the driver's seat (for example, on the right side of the vehicle body) can be defined as the second sensor 30R, and the electronic display far from the driver's seat (for example, on the right side of the vehicle body) can be defined as the second electronic display 20R. The distance between the driver's eyes detected by the first sensor 30L and the first electronic display 20L is S1, and the distance between the driver's eyes detected by the second sensor 30R and the second electronic display 20R is S2. In some embodiments, if the driver's eyes turn to the left or right, the electronic display on that side will start to adjust the display screen; if the driver's eyes are facing forward or to the other side, that side will not be calculated to save system computing power. In some embodiments, a coordinate system is established, with the y-axis perpendicular to the electronic display, the x-axis parallel to the left and right, and the z-axis parallel to the top and bottom for calculation and arrangement as shown in Table 4:

TABLE 4

| | | The distance between |
|---|---|---|
| Magnification M | | the driver's eyes and |
| of electronic display | | the electronic display |
| Left and right parallel | FOV′ movement | −2*(arctan(x/S))/M |
| to the electronic display | amount | |
| direction movement x | | |
| Up and down parallel | FOV′ movement | −2*(arctan(z/S))/M |
| to the electronic | amount | |
| display direction | | |
| movement z | | |
| Forward and backward | FOV′ size | S/(S − y) |
| facing the electronic | change | |
| display movement y | | |

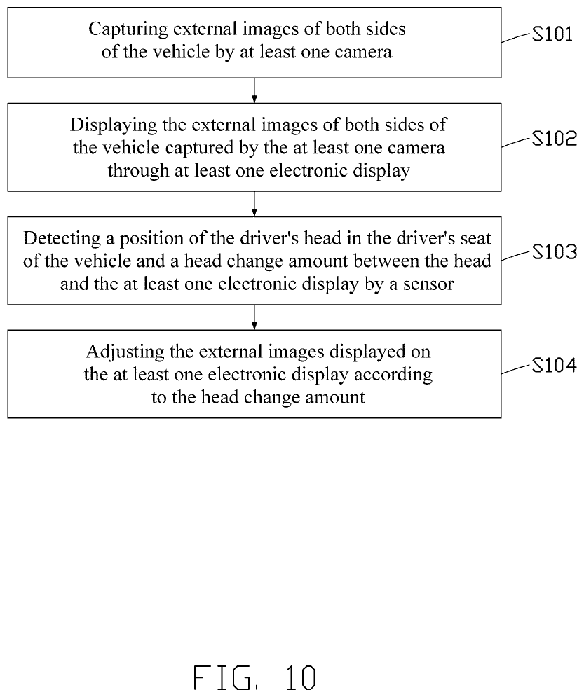

Referring to FIG. 10, the embodiment of the present application also provides a display method of the electronic rearview mirror, which is applied to the electronic rearview mirror shown in FIGS. 1 to 9. The display method of the electronic rearview mirror may include the following steps:

At block S101, capturing external images of both sides of the vehicle by at least one camera.

In some embodiments, capturing external images of both sides of the vehicle by the at least one camera 10. The configuration and capturing of the at least one camera 10 can be found in the description of the related embodiments shown in FIGS. 1 to 9, which will not be described again here.

At block S102, displaying the external images of both sides of the vehicle captured by the at least one camera through at least one electronic display.

In some embodiments, displaying the external images of both sides of the vehicle captured by the at least one camera through the at least one electronic display 20. The configuration and displaying of the at least one electronic display 20 can be found in the description of the related embodiments shown in FIGS. 1 to 9, which will not be described again here.

At block S103, detecting a position of the driver's head in the driver's seat of the vehicle and a head change amount between the head and the at least one electronic display by a sensor.

In some embodiments, detecting the position of the driver's head in the driver's seat of the vehicle and the head change amount between the head and the at least one electronic display 20 by the sensor 30, which can be found in the description of the related embodiments shown in FIGS. 1 to 9, which will not be described again here.

In some embodiments, when the sensor 30 detects that the driver's head or eyes rotate more than a preset threshold, the processor 40 determines that the driver's head or eyes move, and the sensor 30 detects the head change amount between the driver's head or eyes and the at least one electronic display 20. When the sensor 30 detects that the rotation of the driver's head or eyes does not exceed the preset threshold, the processor 40 determines that the driver's head or eyes have not moved, and the sensor 30 does not start detecting the head change amount between the driver's head or eyes and the at least one electronic display 20. In some embodiments, the preset threshold may be, but is not limited to, 3°, that is, when the sensor 30 detects that the driver's head or eyes have rotated more than 3°, the processor 40 determines that the driver's head or eyes have moved.

At block S104, adjusting the position of the at least one electronic display displaying the external images according to the head change amount.

In some embodiments, adjusting the external images displayed on the at least one electronic display 20 according to the head change amount, which can be found in the description of the related embodiments shown in FIGS. 1 to 9, which will not be described again here.

In some embodiments, the sensor 30 detects the head change amount between the driver's head or eyes and the at least one electronic display, which may include the movement amount in the three axes of x, y, and z, and then calculates and adjusts the position of the at least one electronic display 20 displaying the external images as described in the relevant embodiments of FIGS. 1 to 9.

In some embodiments, when the sensor 30 detects that the driver's head or eyes rotate back to the original position, the processor 40 adjusts the at least one electronic display 20 to display the external images back to the original position.

Wherein, block S104 may further include: cropping or zooming in/out the external images to adjust the screen size of the external image, and moving the position of the external image.

Wherein, block S103 and S104 may further include: when the distance between the head and the electronic display is detected to be decreased, the screen size of the external image displayed by the electronic display is increased (similar to zoom in effect); when the sensor detects that the distance between the head and the electronic display is increased, the screen size of the external image displayed by the electronic display is decreased (similar to zoom out effect); when the sensor detects that the head changes relative to the electronic display in the first direction, the position of the electronic display displaying the external image is adjusted to move toward a second direction; wherein the second direction is opposite to the first direction.

In the electronic rearview mirror, the head change amount between the driver's head and the electronic display is detected by the sensor to determine the driver's visual changes during driving, and the position of the electronic display displaying the external image is adjusted according to the detected head change amount to provide the vehicle's external image suitable for the driver's needs, meet the driver's real-time driving needs, and greatly facilitate the driver's driving.

It is to be understood that the embodiments shown in FIG. 1 and the full text are all illustrated with the left-hand drive as an example. The camera 10, the electronic display 20, the door 202, and the driver's seat 203 shown in the figures are all located on the left side of the vehicle body 201. The embodiments of right-hand drive are similar and will not be described here.

It should be noted that any steps and any technical features of the above-mentioned embodiments of the present application can be freely and arbitrarily combined, and the combined technical solutions are also within the scope of the present application.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An electronic rearview mirror comprising:
at least one camera configured to capture external images on both sides of a vehicle;
at least one electronic display configured to display the external images on both sides of the vehicle captured by the at least one camera;
a sensor configured to detect a position of a driver's head in a driver's seat of the vehicle and a head change amount between the head and the at least one electronic display; and
a processor configured to adjust the external images displayed on the at least one electronic display according to the head change amount.

2. The electronic rearview mirror of claim 1, wherein the processor adjusts the external images displayed on the at least one electronic display according to the head change amount by:
cropping the external images captured by at least one camera to adjust a ratio of the external images displayed on the at least one electronic display.

3. The electronic rearview mirror of claim 2, wherein when the sensor detects that the distance between the driver's head and the at least one electronic display is decreased, the processor zooms in the external images displayed on the at least one electronic display.

4. The electronic rearview mirror of claim 2, wherein when the sensor detects that the distance between the driver's head and the at least one electronic display is increased, the processor zooms out the external images displayed on the at least one electronic display.

5. The electronic rearview mirror of claim 1, wherein when the sensor detects that the driver's head changes relative to the at least one electronic display in a first direction, the processor adjusts the external images displayed on the at least one electronic display to move in a second direction opposite to the first direction.

6. The electronic rearview mirror of claim 1, wherein the head change amount between the head and the at least one electronic display is a movement amount of the driver's eyes detected by the sensor.

7. The electronic rearview mirror of claim 6, wherein the movement amount of the driver's eyes comprises a changing distance and a changing angle between the driver's eyes and the at least one electronic display.

8. The electronic rearview mirror of claim 1, wherein the sensor is installed on the at least one electronic display.

9. The electronic rearview mirror of claim 1, wherein the electronic rearview mirror comprises two cameras installed on both sides of the vehicle, the two cameras are configured to capture the external images on both sides of the vehicle.

10. The electronic rearview mirror of claim 9, wherein the electronic rearview mirror comprises two electronic displays installed on both sides of the vehicle, each of the two electronic displays is configured to display the external images captured by the corresponding camera.

11. A display method of an electronic rearview mirror, the display method comprising:
capturing external images of both sides of a vehicle by at least one camera;
displaying the external images of both sides of the vehicle captured by the at least one camera through at least one electronic display;
detecting a position of a driver's head in a driver's seat of the vehicle and a head change amount between the driver's head and the at least one electronic display by a sensor; and
adjusting the external images displayed on the at least one electronic display according to the head change amount.

12. The display method of claim 11, wherein adjusting the external images displayed on the at least one electronic display according to the head change amount, by:
cropping the external images captured by at least one camera to adjust a ratio of the external images displayed on the at least one electronic display.

13. The display method of claim 12, further comprising:
when the sensor detects that the distance between the driver's head and the at least one electronic display is decreased, the processor zooms in the external images displayed on the at least one electronic display displaying the external images.

14. The display method of claim 12, further comprising:
when the sensor detects that the distance between the driver's head and the at least one electronic display is increased, the processor zooms out the external images displayed on the at least one electronic display.

15. The display method of claim 11, further comprising:
when the sensor detects that the driver's head changes relative to the at least one electronic display in a first direction, the processor adjusts the external images displayed on the at least one electronic display to move in a second direction opposite to the first direction.

16. The display method of claim 11, wherein the head change amount between the head and the at least one electronic display is a movement amount of the driver's eyes detected by the sensor.

17. The display method of claim 16, wherein the movement amount of the driver's eyes comprises a changing distance and a changing angle between the driver's eyes and the at least one electronic display.

18. The display method of claim 11, wherein the sensor is installed on the at least one electronic display.

19. The display method of claim 10, wherein the electronic rearview mirror comprises two cameras installed on both sides of the vehicle, the display method comprises:
capturing the external images on both sides of the vehicle by the two cameras.

20. The display method of claim 19, wherein the electronic rearview mirror comprises two electronic displays installed on both sides of the vehicle, the display method comprises:
displaying the external images captured by the corresponding camera through each of the two electronic displays.
